(19) United States
(12) Patent Application Publication
(10) Pub. No.: US 2012/0019430 A1
(43) Pub. Date: Jan. 26, 2012

(54) RADIO ANTENNA INCLUDING IMPROVED MEANS OF RIGIDIFICATION

(75) Inventor: Christian Desagulier, Paris (FR)

(73) Assignee: ASTRIUM SAS, Paris (FR)

(21) Appl. No.: 13/260,813

(22) PCT Filed: Apr. 2, 2010
(86) PCT No.: PCT/EP2010/054456

§ 371 Date: Sep. 28, 2011

(30) Foreign Application Priority Data
Apr. 2, 2009 (FR) 0952150

(51) Int. Cl. H01Q 1/12

(52) U.S. Cl. 343/892; 343/878

(57) ABSTRACT

A radio antenna, in particular for a spacecraft, including a reflector and a rear structure supporting said reflector, and also a rigidification membrane added on to the reflector so as to limit the displacement of a peripheral portion of the reflector in a direction parallel to a central axis of this reflector, where said rigidification membrane is separate from the rear supporting structure.

### TECHNICAL FIELD

The present invention relates to the field of reflector radio antennae, and concerns in particular an antenna for a spacecraft, such as a telecommunications satellite.

### STATE OF THE PRIOR ART

The antennae of spacecrafts must satisfy specifications notably concerning the reflectivity of their reflectors, but also the mechanical properties of the fastenings of the reflectors to the spacecrafts, which are subject to the vibratory, acoustic and dynamic stresses caused by space launchers. These antennae must also satisfy specifications concerning their thermoelastic properties in orbit.

Since the level of acoustic stresses caused by the launchers is very difficult to predict, it is preferable that these antennae should be almost insensitive to acoustic efforts, in order to limit the risks of under-dimensioning or over-dimensioning of the reflectors' fastenings to the spacecrafts.

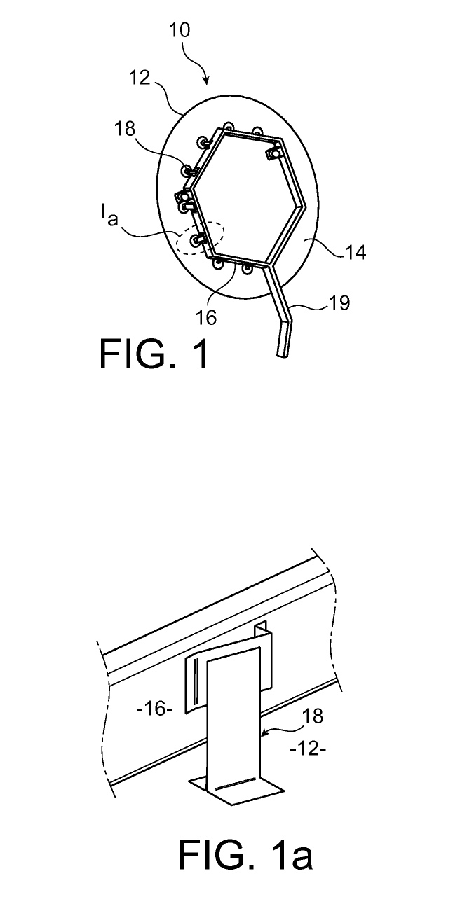

FIGS. 1 and 1a represent an example of a radio antenna 10 (FIG. 1) for a telecommunications satellite operating at frequencies of between 12 GHz and 18 GHz approximately (Ku band), of a known type.

Reflector 12 of antenna 10 includes a body 14 of the sandwich type formed from a honeycomb structure on to which are affixed a front skin—commonly called the active skin—and a rear skin, where each of these skins consists of a sheet of carbon fibres sunk in an epoxy resin.

The reflector 12 of antenna 10 is supported by a rigid tubular rear structure 16, which is for example hexagonal in shape, centred on an axis of the reflector, and smaller in size than the reflector.

The rear structure 16 is connected to the rear skin of reflector 12 by angles 18 (FIG. 1a) capable of providing the mechanical properties of the antenna at launch and insertion into orbit of the satellite fitted with this antenna, and also a thermomechanical decoupling between reflector 12 and rear structure 16 when the satellite is in orbit. In addition, the rear structure 16 is supported by a support arm 19 intended to provide the connection between the antenna 10 and the satellite.

The carbon fibres of the sheets of the abovementioned front and rear skins are positioned in the form of triaxial fabrics which are characterised by near-isotropic mechanical properties, and by the presence of through-perforations which are regularly distributed over their surface.

These perforations allow the mass of the reflector to be reduced, and communicate with cells in the honeycomb structure, such that this type of reflector is insensitive to vibratory stresses, particularly to acoustic stresses at the launch of the satellite fitted with the antenna 10.

In particular, this allows displacements in the direction of the axis of the reflector, of a radially external part of the reflector, found between the peripheral edge of this reflector and its part attached to the angles 18 of rear structure 16, to be limited, these displacements being likely to cause incipient breakages within the reflector.

The composite materials used in these antennae generally make them very light, which constitutes an essential advantage in the field of space applications.

However, the reflectivity properties of the reflectors of the type described above are not satisfactory at frequencies of approximately between 20 GHz and 40 GHz (Ka band), due to the fact that these reflectors are perforated.

Solutions have been proposed, which consist, using an antenna of the type described above, in reducing the dimensions of the perforations of the active skin, or even in replacing the perforated active skin by an unperforated skin, but the antennae obtained in this manner have proved to be too sensitive to acoustic stresses.

Moreover, at these higher frequencies, the tolerances relative to the profiles of the reflectors are stricter, leading to more severe requirements in terms of manufacturing precision, and of stability over time of the reflectors, typically of the order of 30 μm RMS, which should be compared with 150 μm RMS in the case of satellites operating at the lower frequencies of the Ku band.

However, the sandwich structures of the antenna reflectors of the type described above do not easily enable the criteria required by operation in the Ka band to be satisfied.

### SUMMARY OF THE INVENTION

One aim of the invention is notably to provide a simple, economic and efficient solution to these problems, allowing the abovementioned disadvantages to be avoided.

Its goal is notably a radio antenna for a spacecraft, capable of operating at the frequencies of the Ka band, and satisfying the requirements imposed on this type of antenna, notably in respect of the sensitivity of the antenna to the vibratory stresses caused by the launchers, the precision of manufacture of the profile of the antenna's reflector and the stability of this profile over time and, generally, the antenna's thermomechanical properties in orbit.

The invention proposes to this end a radio antenna, in particular for a spacecraft, including a reflector and a rear structure supporting said reflector, wherein the antenna includes a rigidification membrane added on to the reflector to limit the displacement of a peripheral portion of the reflector in a direction parallel to a central axis of the reflector, where this rigidification membrane is separate from the rear supporting structure.

The rigidification membrane enables the impact of vibratory stresses, notably acoustic stresses, on the rear supporting structure of the antenna's reflector to be reduced. This notably makes possible the use of a solid active skin, i.e. one which is not perforated, so as to give the reflector optimal reflectivity properties, and also to improve the precision and the stability of the profile of this reflector.

Since the reflector has an active face and a rear face, the rigidification membrane preferably includes a central part positioned facing the reflector's active face.

This enables the rigidification capacities of the abovementioned membrane to be optimised.

The antenna advantageously includes fastenings of said rigidification membrane on the to peripheral portion of the reflector.

The fastenings can be configured for an attachment of the membrane on to the active face of the reflector, or for an attachment of a folded peripheral edge of the membrane on to the rear face of the reflector.

The membrane thus enables a possible deformation of the peripheral portion of the reflector facing towards the front of the latter to be limited.

As a variant, and preferably, the rigidification membrane can include a peripheral part folded on a peripheral edge of the reflector, positioned facing the rear face of the reflector so as to be coupled with the supporting rear structure.

This configuration allows the membrane to be in contact with the active and rear faces of the reflector, in the area of the peripheral edge of the latter, such that the membrane then enables a possible deformation of the peripheral portion of the reflector oriented towards the front or towards the rear of the reflector to be limited.

In this case, the antenna can advantageously include rods attached firstly to said rear supporting structure and secondly to the peripheral portion of the reflector, where said folded peripheral part of the rigidification membrane is then attached on to these rods.

Generally, the rigidification membrane is preferably stretched so as to provide an optimal rigidification of the reflector.

In addition, the membrane is preferably solid, i.e. having no perforations. This enables this membrane to dampen any acoustic vibrations in a particularly effective manner.

Generally, the antenna is advantageously configured to operate in a predetermined band of frequencies of the microwave spectrum, where this band of frequencies can in particular be within the Ka band.

The use of an unperforated active face, made possible by the invention, is indeed particularly advantageous in the Ka band, as was explained above.

The rigidification membrane is preferably made from a material which is transparent to radio waves of frequencies included in said frequency band.

Said material is advantageously a composite material including fibres sunk in a hardened resin.

This type of material has the advantage that it is very light in weight, and has satisfactory mechanical resistance.

In addition, this type of material makes it possible to manufacture the rigidification membrane as a single piece with the active face of the body, when the latter is itself made from a comparable composite material.

The abovementioned fibres are advantageously aramid fibres, preferably of the Kevlar (registered trademark) type, or quartz fibres, where the resin in which these fibres are sunk is, for example, an epoxy resin.

As a variant, however, the rigidification membrane can be made from a material which is not transparent to said radio waves when the positioning of this membrane is such that there is no risk that the latter will make the antenna's reflectivity properties insufficient.

Generally, the rigidification membrane according to the invention has the advantage that it is particularly simple to manufacture.

### BRIEF DESCRIPTION OF THE ILLUSTRATIONS

The invention will be better understood, and other details, advantages and characteristics of it will appear, on reading the following description given as a non-restrictive example, and with reference to the appended illustrations, in which:

FIG. 1, which has already been described, is a schematic perspective view of a radio antenna of a known type;

FIG. 1a, which has already been described, is a larger-scale view of detail Ia of FIG. 1;

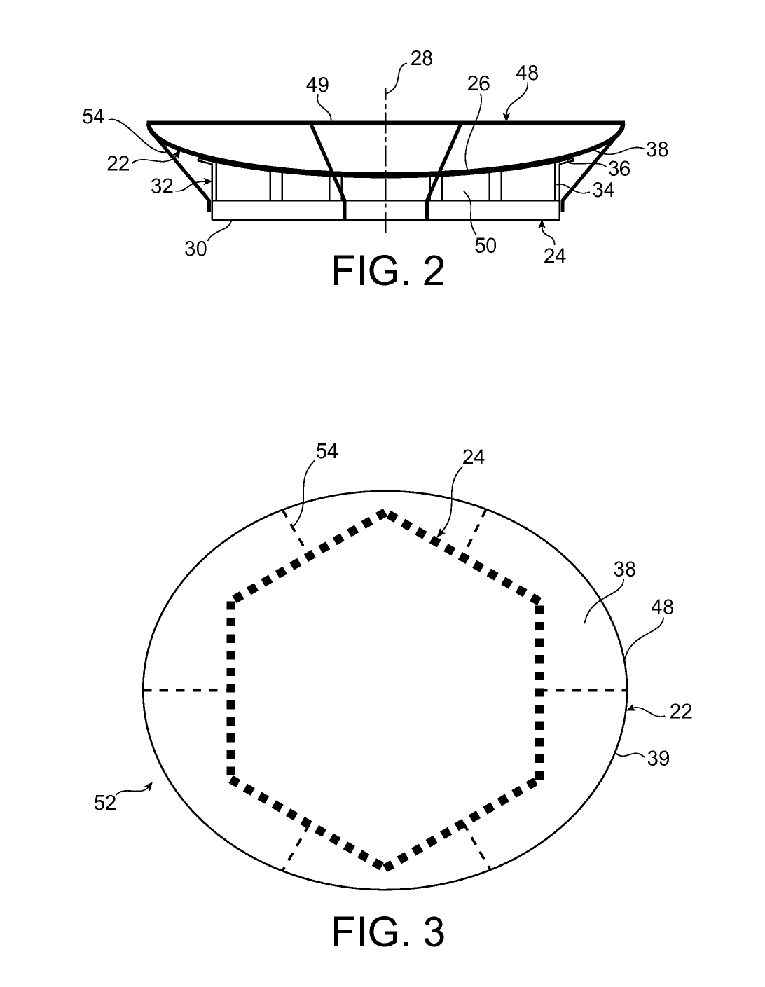

FIG. 2 is a partial schematic view as an axial section of a radio antenna according to a preferred embodiment of the invention;

FIG. 3 is a partial schematic view from the front of the antenna of FIG. 2.

### DETAILED DESCRIPTION OF A PREFERRED EMBODIMENT

FIGS. 2 and 3 represent a radio antenna 20 according to a preferred embodiment of the invention.

Antenna 20 includes a reflector 22 and a rear structure 24 supporting this reflector 22.

Reflector 22 includes a body 26 the general shape of which is that of a paraboloid of revolution, having an axis 28, formed from a sandwich structure including a honeycomb core on which are affixed two skins, respectively front and rear skins, formed from carbon fibres sunk in a hardened epoxy resin, and set out in the form of a unidirectional web. The skin and the front face of the reflector are commonly called, respectively, the active skin and face, such that the terms “front” and “active” are equivalent in the present text.

Rear supporting structure 24 is similar to rear structure 16 of the antenna of known type represented in FIG. 1.

This structure 24 includes a hexagonal tubular part 30 which extends in a plane perpendicular to axis 28 of the reflector, and which is centred on this axis 28, and an arm (not visible in FIG. 2) intended to connect the tubular part 30 to a spacecraft, such as a satellite.

Tubular part 30 of rear supporting structure 24 includes angles 32 connecting body 26 of reflector 22 to rear structure 24.

Angles 32 each include a blade 34 which extends roughly parallel to the axis 28 of reflector 22, and which is connected securely, at its front end, to a retaining bracket 36 affixed on the rear skin of body 26 of the reflector, and at its rear end to the tubular part 30 of rear supporting structure 24.

The blades 34 of the angles 32 allow a thermomechanical decoupling between reflector 22 and rear supporting structure 24.

Rear structure 24 is of smaller radial size than reflector 22, such that the positioning of retaining brackets 36 of angles 32 on body 26 of this reflector internally define a peripheral portion 38 of reflector 22. This peripheral portion 38 extends as far as the outer edge 39 of the reflector.

Reflector 22 includes a rigidification membrane 48 including a flat and stretched central part, facing the active face of reflector 22, and a peripheral part 50 which is folded on the outer edge 39 of the reflector, and which extends facing the rear face of the latter.

Rigidification membrane 48 is intended to limit the displacement of peripheral portion 38 of the reflector in its axis 28 when the reflector is subject to vibratory stresses.

As will be shown more clearly in what follows, peripheral part 50 of the membrane is intended for the attachment of membrane 48 to rear supporting structure 24.

In the example described in FIGS. 2 and 3, antenna 52 includes connecting rods 54 positioned such that one end of each of these rods 54 is attached to the tubular part 30 of supporting structure 24, and the other end of each rod 54 is attached to the rear face of reflector 22, in the area of the outer edge 39 of the latter. These connecting rods 54 are regularly distributed around the axis 28 of the reflector.

Peripheral part 50 of rigidification membrane 48 is attached to connecting rods 54, for example by gluing, such that the membrane is stretched in its central part 49.

In this manner, rigidification membrane 48 effectively opposes the displacement of the peripheral portion 38 of the reflector parallel to axis 28 of this reflector.

Rigidification membrane 48 is made from a composite material which is transparent to radio waves. This material consists, for example, of a fabric of aramid fibres sunk in a hardened epoxy resin, such that membrane 48 is solid, i.e. unperforated.

Rigidification membrane 48 thus enables the acoustic vibrations likely to be propagated towards the active face of the reflector to the dampened, at least partially.

As a variant, membrane 48 may however be formed from a perforated fabric, for example of the bidirectional or triaxial type.

As another variant, it is possible for rigidification membrane 48 not to be folded towards the rear of reflector 22, and for it to be attached to the active face of the reflector, in the area of the peripheral portion 38 of the latter.

In addition, rigidification membrane 48 may be made from another material such as, for example, a composite material with quartz or comparable fibres sunk in any type of appropriate resin.

The material of the rigidification membrane 48 is preferably chosen such that it has a thermoelastic coefficient close to that of the material forming the body of the reflector, in order to optimise the antenna's thermomechanical properties.

The shape of body 26 of reflector 22 can also, without going beyond the scope of the invention, be different from that described above, such as for example a globally flat embossed shape. In this case, rigidification membrane 48 can also be in contact with the reflector's active face.

1-9. (canceled)

10. A radio antenna, in particular for a spacecraft, including a reflector and a rear structure supporting said reflector, wherein the antenna includes a rigidification membrane added on to the reflector so as to limit the displacement of a peripheral portion of the reflector in a direction parallel to a central axis of this reflector, where this rigidification membrane is separate from said rear supporting structure.

11. A radio antenna according to claim 10, wherein the reflector has an active face and a rear face, and said rigidification membrane has a central part positioned facing said active face of the reflector.

12. A radio antenna according to claim 10, including fastenings of said membrane on to the peripheral part of the reflector.

13. A radio antenna according to claim 10, wherein the membrane includes a peripheral part folded on a peripheral edge of the reflector and positioned facing the rear face of the reflector so as to be coupled with the rear supporting structure.

14. A radio antenna according to claim 13, including rods which are attached firstly to said rear supporting structure and secondly to the peripheral portion of the reflector, and on to which is attached said peripheral part of the membrane.

15. A radio antenna according to claim 10, configured to operate in a predetermined frequency band of the microwave spectrum.

16. A radio antenna according to claim 15, wherein said frequency band is included in the Ka band.

17. A radio antenna according to claim 15, wherein said rigidification membrane is made from a material which is transparent to radio waves the frequency of which is included in said frequency band.

18. A radio antenna according to claim 17, wherein said material is a composite material including fibres sunk in a hardened resin.
